(19) United States
(12) Patent Application Publication
(10) Pub. No.: US 2024/0037037 A1
(43) Pub. Date: Feb. 1, 2024

(54) Software Assisted Hardware Offloading Cache Using FPGA

(71) Applicants: Krishna Kumar Simmadhari Ramadass, Bangalore (IN); Rajesh Banginwar, Bangalore (IN); Vasu Devunuri, Bangalore (IN)

(72) Inventors: Krishna Kumar Simmadhari Ramadass, Bangalore (IN); Rajesh Banginwar, Bangalore (IN); Vasu Devunuri, Bangalore (IN)

(21) Appl. No.: 18/478,602

(22) Filed: Sep. 29, 2023

(51) Int. Cl. G06F 12/0831; G06F 12/0868

(52) U.S. Cl. CPC G06F 12/0831; G06F 12/0868

(57) ABSTRACT

Circuitry, systems, and methods are provided for an integrated circuit device including a memory storing a data structure, a cache storing a portion of the structure data, and an acceleration function unit providing hardware acceleration for a host device. The acceleration function unit may provide the hardware acceleration by intercepting a request from the host device to access the memory, where the request comprises an address corresponding to a data node of the data structure, identifying a next data node based at least in part on decoding the data node, and loading the next data node into the cache for access by the host device.

### BACKGROUND

The present disclosure relates to resource-efficient circuitry of an integrated circuit that can reduce memory access latency.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Memory is increasingly becoming the single most expensive component in datacenters and in electronic devices driving up the overall total cost of ownership (TCO). More efficient usage of memory via memory pooling and memory tiering is seen as the most promising path to optimize memory usage. For example, the memory may store structured data sets specific to applications being used. However, searching data from a structure set of data is computer processor unit (CPU) intensive. For example, the CPU is locked doing memory read cycles from the structured data set in memory. As such, the CPU may spend significant time identifying, retrieving, and decoding data from the memory.

With the availability of compute express link (CXL) and/or other device/CPU-to-memory standards, there is a foundational shift in the datacenter architecture with respect to disaggregated memory tiering architectures as a means of reducing the TCO. Memory tiering architectures may include pooled memory, heterogeneous memory tiers, and/or network connected memory tiers all of which enable memory to be shared by multiple nodes to drive a better TCO. Intelligent memory controllers that manage the memory tiers are a key component of this architecture. However, tiered memory controllers residing outside of a memory coherency domain may not have direct access to coherency information from the coherent domain making such deployments less practical and/or impossible.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device, in accordance with an embodiment of the present disclosure;

FIG. 2 is a block diagram of the integrated circuit device of FIG. 1, in accordance with an embodiment of the present disclosure;

FIG. 3 is a block diagram of programmable fabric of the integrated circuit device of FIG. 1, in accordance with an embodiment of the present disclosure;

FIG. 4 is a block diagram of a system including a central processing unit (CPU) and the integrated circuit device of FIG. 3, in accordance with an embodiment of the present disclosure;

FIG. 5 is a flowchart of an example method for programming the integrated circuit device of FIG. 3 to intelligently prefill a cache with data, in accordance with an embodiment of the present disclosure; and

FIG. 6 is a block diagram of a system as a CXL2 type device including a CPU and the integrated circuit device of FIG. 3, in accordance with an embodiment of the present disclosure;

FIG. 7 is a flowchart of an example method for prefilling a cache with data used for an application, in accordance with an embodiment of the present disclosure; and

FIG. 8 is a block diagram of a data processing system that may incorporate the integrated circuit device of FIG. 1, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As previously noted, accessing and using structured sets of data stored in a memory may be a CPU-intensive process. Access to structured data stored in memory by a hardware cache may provide faster access to the memory. That is, the hardware cache may be prefill with data used by the CPU to perform applications to decrease memory access latencies. In certain instances, a programmable logic device may sit on a memory bus between the CPU and the memory and snoop on requests (e.g., read request, write requests) from the CPU to the memory. Based on the requests, the programmable logic device may prefill the cache with the data to decrease memory access latencies. To this end, the programmable logic device may be programmed (e.g., configured) to understand memory access patterns, the memory layout, the type of structured data, and so on. For example, the programmable logic device may read ahead to the next data by decoding the data stored in the memory and using memory pointers in the structure. The programmable logic device may prefill the case based on a next predicted access to the memory without CPU intervention. As such, cache loaded by the programmable logic device that understands memory access patterns and the structure of the data set stored in the memory may increase a number of cache hits and/or keep the cache warm, thereby improving device throughput.

In an example, the device may be a compute express link (CXL) type 2 device or other device that includes general purpose accelerators (e.g., GPUs, ASICs, FPGAs, and the like) to function with double-data rate (DDR), high bandwidth memory (HBM), host-managed device memory (HDM), or other types of local memory. For example, the host-managed device memory may be made available to the host via the device (e.g., the FPGA 70). As such, the CXL type 2 device enable the implementation of a cache that a host can see without using direct memory access (DMA) operations. Instead, the memory can be exposed to the host operating system (OS) like it is just standard memory even if some of the memory may be kept private from the processor. The host may access one of the structured data sets on the HDM. When the memory access is completed, the FPGA may snoop on a CXL cache snoop request from a HomeAgent to check for a cache hit. Based on the snoop request, the FPGA may identify data and load the data into the cache for the host. As such, subsequent requests from the host may result in a cache hit, which may decrease memory access latencies and improve device throughput. In this way, the FPGA may act as an intelligent memory controller for the device.

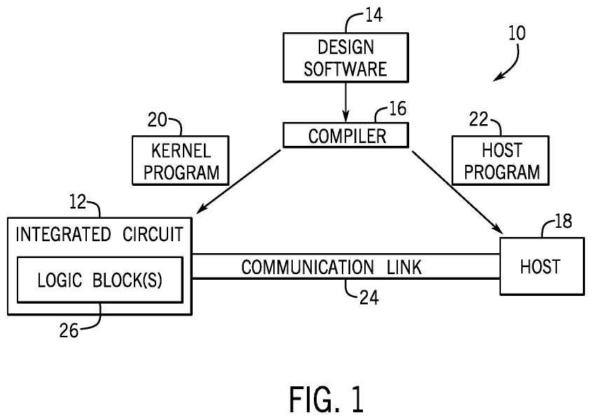

With the foregoing in mind, FIG. 1 is a block diagram of a system 10 that may implement one or more functionalities. For example, a designer may desire to implement functionality, such as the operations of this disclosure, on an integrated circuit device 12 (e.g., a programmable logic device, such as a field programmable gate array (FPGA) or an application specific integrated circuit (ASIC)). In some cases, the designer may specify a high-level program to be implemented, such as an OpenCL® program or SYCL®, which may enable the designer to more efficiently and easily provide programming instructions to configure a set of programmable logic cells for the integrated circuit device 12 without specific knowledge of low-level hardware description languages (e.g., Verilog or VHDL). For example, since OpenCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12. Additionally or alternatively, a subset of the high-level program may be implemented using and/or translated to a lower level language, such as a register-transfer language (RTL).

The designer may implement high-level designs using design software 14, such as a version of INTEL® QUARTUS® by INTEL CORPORATION. The design software 14 may use a compiler 16 to convert the high-level program into a lower-level description. In some embodiments, the compiler 16 and the design software 14 may be packaged into a single software application. The compiler 16 may provide machine-readable instructions representative of the high-level program to a host 18 and the integrated circuit device 12. The host 18 may receive a host program 22 which may be implemented by the kernel programs 20. To implement the host program 22, the host 18 may communicate instructions from the host program 22 to the integrated circuit device 12 via a communications link 24, which may be, for example, direct memory access (DMA) communications or peripheral component interconnect express (PCIe) communications. In some embodiments, the kernel programs 20 and the host 18 may enable configuration of a logic block 26 on the integrated circuit device 12. The logic block 26 may include circuitry and/or other logic elements and may be configured to implement arithmetic operations, such as addition and multiplication.

The designer may use the design software 14 to generate and/or to specify a low-level program, such as the low-level hardware description languages described above. For example, the design software 14 may be used to map a workload to one or more routing resources of the integrated circuit device 12 based on a timing, a wire usage, a logic utilization, and/or a routability. Additionally or alternatively, the design software 14 may be used to route first data to a portion of the integrated circuit device 12 and route second data, power, and clock signals to a second portion of the integrated circuit device 12. Further, in some embodiments, the system 10 may be implemented without a host program 22 and/or without a separate host program 22. Moreover, in some embodiments, the techniques described herein may be implemented in circuitry as a non-programmable circuit design. Thus, embodiments described herein are intended to be illustrative and not limiting.

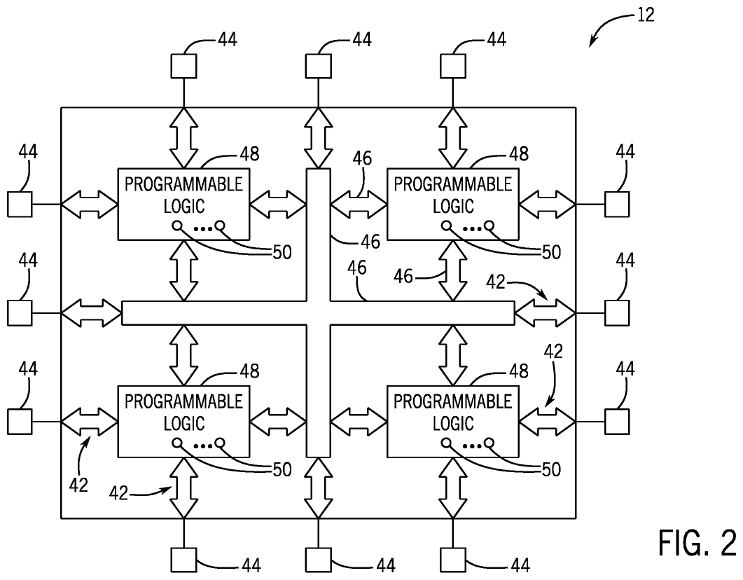

Turning now to a more detailed discussion of the integrated circuit device 12, FIG. 2 is a block diagram of an example of the integrated circuit device 12 as a programmable logic device, such as a field-programmable gate array (FPGA). Further, it should be understood that the integrated circuit device 12 may be any other suitable type of programmable logic device (e.g., a structured ASIC such as eASIC™ by Intel Corporation ASIC and/or application-specific standard product). The integrated circuit device 12 may have input/output circuitry 42 for driving signals off the device and for receiving signals from other devices via input/output pins 44. Interconnection resources 46, such as global and local vertical and horizontal conductive lines and buses, and/or configuration resources (e.g., hardwired couplings, logical couplings not implemented by designer logic), may be used to route signals on integrated circuit device 12. Additionally, interconnection resources 46 may include fixed interconnects (conductive lines) and programmable interconnects (i.e., programmable connections between respective fixed interconnects). For example, the interconnection resources 46 may be used to route signals, such as clock or data signals, through the integrated circuit device 12. Additionally or alternatively, the interconnection resources 46 may be used to route power (e.g., voltage) through the integrated circuit device 12. Programmable logic 48 may include combinational and sequential logic circuitry. For example, programmable logic 48 may include look-up tables, registers, and multiplexers. In various embodiments, the programmable logic 48 may be configured to perform a custom logic function. The programmable interconnects associated with interconnection resources may be considered to be a part of programmable logic 48.

Programmable logic devices, such as the integrated circuit device 12, may include programmable elements 50 with the programmable logic 48. In some embodiments, at least some of the programmable elements 50 may be grouped into logic array blocks (LABs). As discussed above, a designer (e.g., a user, a customer) may (re)program (e.g., (re)configure) the programmable logic 48 to perform one or more desired functions. By way of example, some programmable logic devices may be programmed or reprogrammed by configuring programmable elements 50 using mask programming arrangements, which is performed during semiconductor manufacturing. Other programmable logic devices are configured after semiconductor fabrication operations have been completed, such as by using electrical programming or laser programming to program the programmable elements 50. In general, programmable elements 50 may be based on any suitable programmable technology, such as fuses, anti-fuses, electrically programmable read-only-memory technology, random-access memory cells, mask-programmed elements, and so forth.

Many programmable logic devices are electrically programmed. With electrical programming arrangements, the programmable elements 50 may be formed from one or more memory cells. For example, during programming, configuration data is loaded into the memory cells using input/output pins 44 and input/output circuitry 42. In one embodiment, the memory cells may be implemented as random-access-memory (RAM) cells. The use of memory cells based on RAM technology as described herein is intended to be only one example. Further, since these RAM cells are loaded with configuration data during programming, they are sometimes referred to as configuration RAM cells (CRAM). These memory cells may each provide a corresponding static control output signal that controls the state of an associated logic component in programmable logic 48. In some embodiments, the output signals may be applied to the gates of metal-oxide-semiconductor (MOS) transistors within the programmable logic 48.

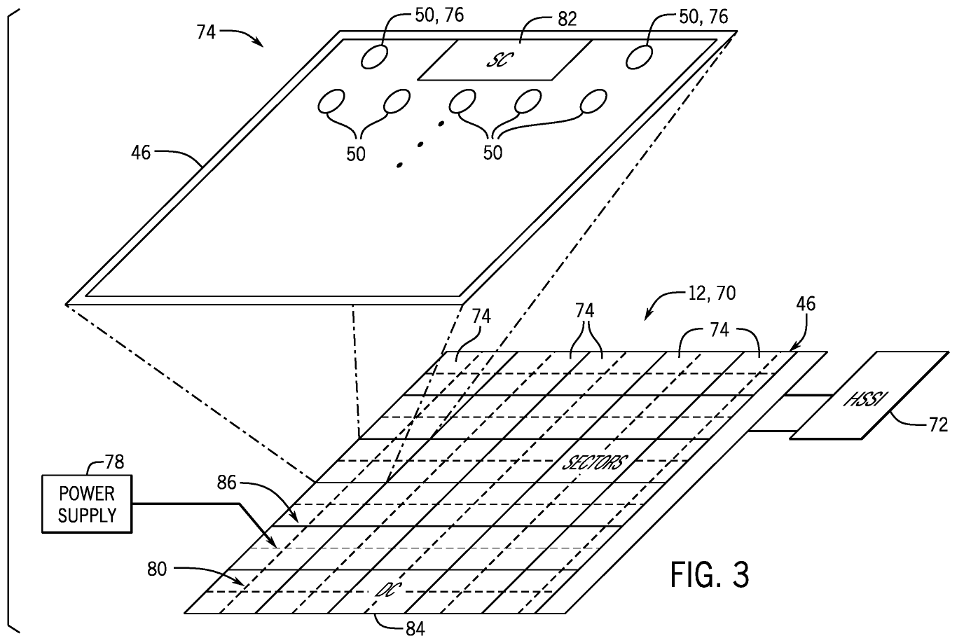

The integrated circuit device 12 may include any programmable logic device such as a field programmable gate array (FPGA) 70, as shown in FIG. 3. For the purposes of this example, the FPGA 70 is referred to as a FPGA, though it should be understood that the device may be any suitable type of programmable logic device (e.g., an application-specific integrated circuit and/or application-specific standard product). In one example, the FPGA 70 is a sectorized FPGA of the type described in U.S. Patent Publication No. 2016/0049941, “Programmable Circuit Having Multiple Sectors,” which is incorporated by reference in its entirety for all purposes. The FPGA 70 may be formed on a single plane. Additionally or alternatively, the FPGA 70 may be a three-dimensional FPGA having a base die and a fabric die of the type described in U.S. Pat. No. 10,833,679, “Multi-Purpose Interface for Configuration Data and Designer Fabric Data,” which is incorporated by reference in its entirety for all purposes.

In the example of FIG. 3, the FPGA 70 may include transceiver 72 that may include and/or use input/output circuitry, such as input/output circuitry 42 in FIG. 2, for driving signals off the FPGA 70 and for receiving signals from other devices. Interconnection resources 46 may be used to route signals, such as clock or data signals, through the FPGA 70. The FPGA 70 is sectorized, meaning that programmable logic resources may be distributed through a number of discrete programmable logic sectors 74. Programmable logic sectors 74 may include a number of programmable elements 50 having operations defined by configuration memory 76 (e.g., CRAM). A power supply 78 may provide a source of voltage (e.g., supply voltage) and current to a power distribution network (PDN) 80 that distributes electrical power to the various components of the FPGA 70. Operating the circuitry of the FPGA 70 causes power to be drawn from the power distribution network 80.

There may be any suitable number of programmable logic sectors 74 on the FPGA 70. Indeed, while 29 programmable logic sectors 74 are shown here, it should be appreciated that more or fewer may appear in an actual implementation (e.g., in some cases, on the order of 50, 100, 500, 1000, 5000, 10,000, 50,000 or 100,000 sectors or more). Programmable logic sectors 74 may include a sector controller (SC) 82 that controls operation of the programmable logic sector 74. Sector controllers 82 may be in communication with a device controller (DC) 84.

Sector controllers 82 may accept commands and data from the device controller 84 and may read data from and write data into its configuration memory 76 based on control signals from the device controller 84. In addition to these operations, the sector controller 82 may be augmented with numerous additional capabilities. For example, such capabilities may include locally sequencing reads and writes to implement error detection and correction on the configuration memory 76 and sequencing test control signals to effect various test modes.

The sector controllers 82 and the device controller 84 may be implemented as state machines and/or processors. For example, operations of the sector controllers 82 or the device controller 84 may be implemented as a separate routine in a memory containing a control program. This control program memory may be fixed in a read-only memory (ROM) or stored in a writable memory, such as random-access memory (RAM). The ROM may have a size larger than would be used to store only one copy of each routine. This may allow routines to have multiple variants depending on “modes” the local controller may be placed into. When the control program memory is implemented as RAM, the RAM may be written with new routines to implement new operations and functionality into the programmable logic sectors 74. This may provide usable extensibility in an efficient and easily understood way. This may be useful because new commands could bring about large amounts of local activity within the sector at the expense of only a small amount of communication between the device controller 84 and the sector controllers 82.

Sector controllers 82 thus may communicate with the device controller 84, which may coordinate the operations of the sector controllers 82 and convey commands initiated from outside the FPGA 70. To support this communication, the interconnection resources 46 may act as a network between the device controller 84 and sector controllers 82. The interconnection resources 46 may support a wide variety of signals between the device controller 84 and sector controllers 82. In one example, these signals may be transmitted as communication packets.

The use of configuration memory 76 based on RAM technology as described herein is intended to be only one example. Moreover, configuration memory 76 may be distributed (e.g., as RAM cells) throughout the various programmable logic sectors 74 of the FPGA 70. The configuration memory 76 may provide a corresponding static control output signal that controls the state of an associated programmable element 50 or programmable component of the interconnection resources 46. The output signals of the configuration memory 76 may be applied to the gates of metal-oxide-semiconductor (MOS) transistors that control the states of the programmable elements 50 or programmable components of the interconnection resources 46.

The programmable elements 50 of the FPGA 40 may also include some signal metals (e.g., communication wires) to transfer a signal. In an embodiment, the programmable logic sectors 74 may be provided in the form of vertical routing channels (e.g., interconnects formed along a y-axis of the FPGA 70) and horizontal routing channels (e.g., interconnects formed along an x-axis of the FPGA 70), and each routing channel may include at least one track to route at least one communication wire. If desired, communication wires may be shorter than the entire length of the routing channel. That is, the communication wire may be shorter than the first die area or the second die area. A length L wire may span L routing channels. As such, a length of four wires in a horizontal routing channel may be referred to as “H4” wires, whereas a length of four wires in a vertical routing channel may be referred to as “V4” wires.

As discussed above, some embodiments of the programmable logic fabric may be configured using indirect configuration techniques. For example, an external host device may communicate configuration data packets to configuration management hardware of the FPGA 70. The data packets may be communicated internally using data paths and specific firmware, which are generally customized for communicating the configuration data packets and may be based on particular host device drivers (e.g., for compatibility). Customization may further be associated with specific device tape outs, often resulting in high costs for the specific tape outs and/or reduced scalability of the FPGA 70.

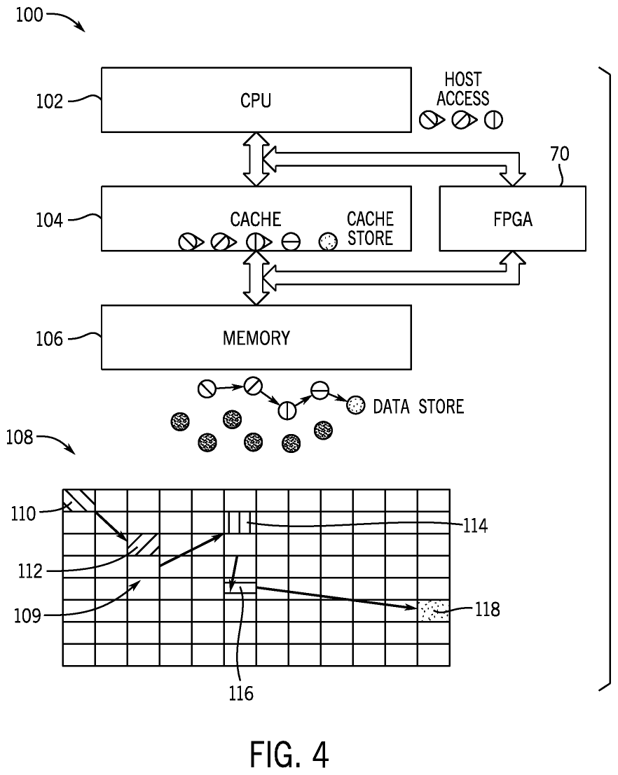

FIG. 4 is a block diagram of a system 100 that includes a central processor unit (CPU) 102 coupled to the FPGA 70. The CPU 102 may be a component in a host (e.g., host system, host domain), such as a general-purpose accelerator, that has inherent access to a cache 104 and a memory 106. The cache 104 may be a cache on the FPGA 70 or a cache 104 in the memory 106. For example, the cache 104 may include an L1 cache, L2 cache, L3 cache, CXL cache, HDM CXL cache, and so on. Additionally or alternatively, the memory 106 may be a local memory, such as a host-managed device memory (HDM), coupled to the host. The memory 106 may store structured sets of data, data structures, data specific for different applications, and the like. For example, the structured data sets stored in the memory 106 may include single linked lists, double linked lists, binary trees, graphs, and so on.

The CPU 102 may access the memory 106 via the cache 104 via one or more requests. For example, the CPU 102 may be coupled to the cache 104 (e.g., as part of the FPGA 70) and the memory 106 via a link and transmit the requests across the link. The link may be any link type suitable for communicatively coupling the CPU 102, the cache 104, and/or the memory 106. For instance, the link type may be a peripheral component interconnect express (PCIe) link or other suitable link type. Additionally or alternatively, the link may utilize one or more protocols built on top of the link type. For instance, the link type may include a type that includes at least one physical layer (PHY) technology. These one or more protocols may include one or more standards to be used via the link type. For instance, the one or more protocols may include compute express link (CXL) or other suitable connection type that may be used over the link. The CPU 102 may transmit a read request to access data stored in the memory 106 and/or a write request to write data to the memory 106 via the link and the cache 104.

Additionally or alternatively, the CPU 102 may access data by querying the cache 104. The cache 104 may store frequently accessed data and/or instructions to improve the data retrieval process. For example, the CPU 102 may first check to see if data is stored in the cache 104 prior to retrieving data from the memory 106. If the data may be found in the cache 104 (referred to herein as a “cache hit”), then the CPU 102 may quickly retrieve it instead of identifying and accessing the data in the memory 106. If the data is not found in the cache 104 (referred to herein as a “cache miss”), then the CPU 102 may retrieve it from the memory 106, which may take a greater amount of time in comparison to retrieving the data from the cache 104.

The FPGA 70 may prefill (e.g., preload) the cache 104 with data from the memory 106 by predicting subsequent memory accesses by the CPU 102. To this end, the FPGA 70 may be coupled to the CPU 102 and/or sit on the memory bus of the host to snoop on the read requests from the CPU 102. Based on the read requests, the FPGA 70 may prefill the cache 104 with data from the memory 106. For example, the FPGA 70 may read ahead the next data by decoding the data stored in the memory 106 and use memory pointers in the data to identify, access, and prefill the cache 104 so that access to additional data is available to the CPU 102 in the cache 104. By decoding the data and reading ahead, the FPGA 70 may load the cache 104 with data that results in a cache hit and/or keeps the cache 104 hot for the CPU 102. This may provide a cache hit for multiple memory accesses by the CPU and provide faster access to data, thereby improving device throughput. Additionally or alternatively, the FPGA 70 may load a whole data set into the cache 104 to improve access to the data. For example, the FPGA 70 may search for a start address of a node using a signature, decode the next node pointer, and prefill (e.g., preload) the cache 104 with the next node. The FPGA 70 may iteratively search for the start address of the next node, decode the next node pointer, and prefill the cache 104 until the FPGA 70 decodes an end or NULL address. Additionally or alternatively, the FPGA 70 may access data stored in databases and/or storage disks. To this end, the FPGA 70 may be coupled to the databases and/or the storage disks to retrieve the data sets.

To this end, the FPGA 70 may be dynamically programmed (e.g., reprogrammed, configured, reconfigured) by the host and/or the external host device with different RTLs to identify (e.g., understand) the different structured data sets stored in the memory 106. For example, the FPGA 70 may be programmed (statically or dynamically) to decode data nodes of the structured data stored within the memory 106 and thus snoop memory read requests from the CPU 102, identify the data corresponding to the request, decode the data, identify a next data node, and prefill the cache 104 with the next likely accessed structured data. The FPGA 70 may be programmed to identify data nodes within the structured data, data nodes within a data stored, details such as the data node description, the data store start address, and/or the data size.

The FPGA 70 may be programmed with custom cache loading algorithms, such as algorithms based on artificial intelligence (AI)/machine learning (ML), custom designed search algorithms, and the like. For example, the FPGA 70 may be programmed with an AI/ML algorithm to decode a data node and identify a likely? next data node based on the decoded data. Additionally or alternatively, the FPGA 70 may prefill the cache 104 based on specific fields of the data set. In a data set that contains all products, when an access to a data set describing a car is done, the FPGA 70 can learn about it and preload the cache with more data nodes describing other cars which the CPU 102 may use in the near future. The FPGA 70 may determine that access to a car data node is completed and identify that future access may be another car that is similar and is stored in a different data node. The FPGA 70 may then prefill the cache 104 with the different data node for faster access by the CPU 102. In this way, the FPGA 70 may accelerate functions of the CPU 102 and/or the host.

In the illustrated example of FIG. 4, the memory 106 may include a memory page 108 with a linked list 109 formed by one or more data nodes 110, 112, 114, 116, and 118. The memory page 108 may be contiguous and mapped to an application being performed by the CPU 102 for faster access. For example, the CPU 102 may write data to the memory page 108 starting a first node 110 (e.g., head node) at a beginning of the linked list 109. The first node 110 may link to a second data node 112 that may link to a third data node 114, and so on. That is, the first node 110 may include a memory pointer that points to the next data node 112 and/or an address of the next data node 112. Additionally or alternatively, the linked list 109 may include start and end signatures that define the first data node 110 and a last data node (e.g., data node 118).

The FPGA 70 may be programmed with RTL logic to understand the linked list 109. For example, the RTL logic may include a physical start address of the memory page 108 and/or the first node 110, a size of a data store, a length of the data structure, a type of data structure, an alignment of the data nodes 110, 112, 114, 116, and 118, and the like. The RTL logic may improve the memory access operation of the FPGA 70 by providing information of the memory page 108, thereby reducing a number of searching operations performed.

Once programmed, the FPGA 70 may start prefilling the cache 104 using the data nodes 110, 112, 114, 116, and 118. For example, the FPGA 70 may snoop on read requests from the CPU 102. The FPGA 70 may identify addresses corresponding to the read requests. If the address falls between the start address of the linked list 109 and the size of the linked list 109, then the FPGA 70 may identify the next data node from any address in the data store. The data store may include the linked list 109 identified by the FPGA 70 in the memory page 108. For example, the FPGA 70 may identify the third data node 114 based on the snooped read request and determine that the address of the third data node 114 is between the start address of the linked list 109 and the size of the linked list 109. The FPGA 70 may then decode the third data node 114 to identify a next data node, such as a fourth data node 116, and/or a next data node address, such as the address of the fourth data node 116. The FPGA 70 may prefill the cache 104 with the fourth data node 116. Additionally or alternatively, the FPGA 70 may prefill the cache 104 with the whole node for faster access by the CPU 102. As such, when the CPU 102 is ready to move from the third data node 114 to the fourth data node 116, the cache 104 already contains the fourth data node 116, which may result in a cache hit. That is, as the CPU 102 traverses through the memory page 108 or the linked list 109, the FPGA 70 may automatically load the next data node in line (e.g., based on next pointers within each data node), thus keeping the cache 104 hot for the CPU 102 (e.g., the host domain). Additionally, multiple memory accesses by the CPU 102 may be a cache hit, thereby improving access to the data. Additionally or alternatively, the cache 104 may periodically perform a cache flush and remove accessed data nodes. In this manner, the host may experience less memory access latencies and improvement in executing software.

While the illustrated example includes the FPGA 70 coupled to and accelerate functions of one CPU 102 with one host, the FPGA 70 be coupled to multiple hosts (e.g., the CPU 102) and accelerate the functions of each respective host. For example, the FPGA 70 may be coupled to the multiple hosts over a CXL bus and snoop on multiple read requests from the hosts. To this end, the FPGA 70 may include one or more acceleration function units (AFUs) that uses programmable fabric of the FPGA 70 to perform the functions of the FPGA 70 described herein. For example, an AFU may be dynamically programmed using the RTL logic to snoop on a read request from the CPU 102, identify a data node and/or an address corresponding to the read request, identify a next data node based on the identified data node, and prefill the cache 104 with the next data node. To support multiple hosts, for example, a first AFU of the FPGA 70 may act as an accelerator for a first host, a second AFU of the FPGA 70 may act as an accelerator for a second host, a third AFU of the FPGA 70 may act as an accelerator for a third host, and so on. That is, each AFU may be individually programmed to support the respective host. Additionally or alternatively, one or more AFUs may be collectively programmed with the same RTL logic to perform the snooping and prefilling operations.

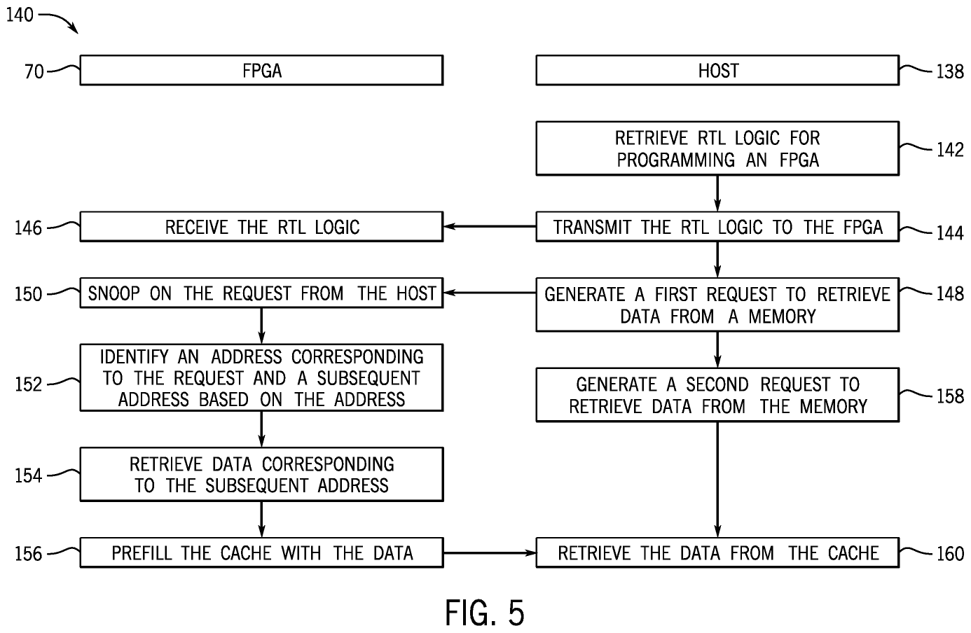

FIG. 5 is a flowchart of an example method 140 for programming the integrated circuit device 12 to intelligently prefill the cache 104 with data. While the method 140 is described using steps in a specific sequence, it should be understood that the present disclosure contemplates that the described steps may be performed in different sequences than the sequence illustrated, and certain described steps may be skipped or not performed altogether.

At block 142, a host 138 may retrieve RTL logic for programming (e.g., configuring) an FPGA 70. The host 138 may be a host system, a host domain, an external host device (e.g., the CPU 102), and the like. The host 138 may store and/or retrieve one or more different RTL logic that may be used to program the FPGA 70. The RTL logic may include pre-defined algorithms that may enable the FPGA 70 to understand and decode different types of data structures. The host 138 may retrieve RTL logic based on the type of data structure within the memory 106.

At block 144, the host 138 may transmit the RTL logic to the FPGA 70. For example, the host 138 may transmit the RTL logic via a link between the host 138 and the FPGA 70. The host 138 may communicate with the configuration management hardware of the FPGA 70 using configuration data packets with the RTL logic. In certain instances, the FPGA 70 may include one or more pre-defined algorithms that may be dynamically enabled based on the applications and the host 138 may transmit an indication indicative of a respective pre-defined algorithm. To this end, the FPGA 70 may include multiple AFUs that may each be programmed by a respective pre-defined algorithm and the host 138 may indicate a respective AFU to perform the operations. Additionally or alternatively, the FPGA 70 may receive and be dynamically programmed with custom logic which may improve access to the memory 106.

At block 146, the FPGA 70 may receive the RTL logic. The FPGA 70 may receive the RTL logic via the link. The FPGA 70 may be dynamically programmed based on the RTL logic to understand the type of data structure within the memory 106, the alignment of the data within the memory 106, the start address of the data structure, the end address of the data structure, and so on. Additionally or alternatively, the FPGA 70 may decode the data structure to identify the next data nodes in order to prefill the cache 104.

At block 148, the host 138 may generate a request to access memory. For example, the CPU 102 may transmit a read request to access data stored in the memory 106. Additionally or alternatively, the CPU 102 may transmit a write request to add data to the memory 106, such as an additional data node to a linked list. The read request may be transmitted from the CPU 102 to the memory 106 along the memory bus. In certain instances, block 148 may occur prior to and/or in parallel with block 146. For example, the CPU 102 may transmit the read request while the FPGA 70 is being programmed by the RTL logic. In another example, the CPU 102 may transmit a write request and continue to create new data nodes to add to the linked list while the FPGA 70 may be programmed by the RTL logic.

At block 150, the FPGA 70 may snoop on the request from the host 138. For example, the FPGA 70 may snoop (e.g., intercept) on the read request being transmitted along the memory bus. Additionally or alternatively, the FPGA 70 may snoop on cache accesses by the CPU 102. In certain instances, a cache snoop message may be sent by a HomeAgent of the host 138 to check for a cache hit after the CPU 102 accesses or attempts to access one of the structured data sets within the memory 106. The FPGA 70 may receive the cache snoop message and snoop on the request based on the message. Additionally or alternatively, the FPGA 70 may intercept all cache 104 and/or memory accesses by the CPU 102 to identify subsequent data structures and load them into the cache 104.

At block 152, the FPGA 70 may identify an address corresponding to the request. The FPGA 70 may decode the snoop message to determine the address corresponding to the read request from the CPU 102. The FPGA 70 with the RTL logic may use details such as the data node description, the data store start address and size, and the like to determine the address corresponding to the request and the address of the next data node. For example, the FPGA 70 may decode the data node at the address corresponding to the request to identify a memory pointer directed to the next data node.

At block 154, the FPGA 70 may retrieve data corresponding to a next data node. With the address, the FPGA 70 may identify the next data node that may be used by the CPU 102 to perform one or more applications. Additionally or alternatively, the FPGA 70 may identify one or more next data nodes, such as for a double linked list, a graph, a tree, and so on.

At block 156, the FPGA 70 may prefill the cache 104 with the next data node. For example, the FPGA 70 may calculate a start address of the next data node and load the next data node into the cache 104. Additionally or alternatively, the FPGA 70 may load the whole data set into the cache 104. As such, the FPGA 70 may keep the cache 104 hot for subsequent read requests from the CPU 102.

At block 158, the host 138 may retrieve the data from the cache. For example, the CPU 102 may finish processing the data node and move to the next data node. The CPU 102 may first access the cache 104 to determine if the next data node is stored. Since the next data node is already loaded into the cache 104, the CPU 102 may access the structured data faster in comparison to accessing the data in the memory 106. That is, host memory read/write access on the already loaded data set is a cache hit which makes access to the structured data faster.

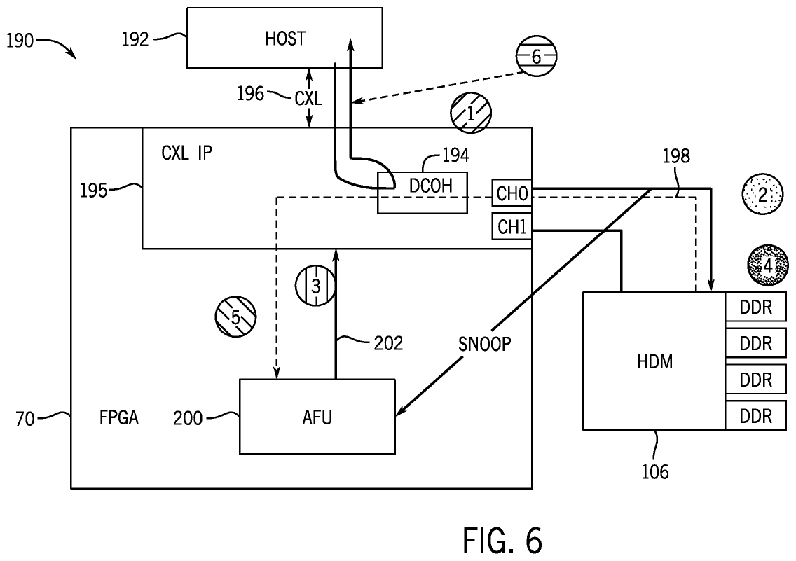

FIG. 6 illustrates a block diagram of a system 190 that includes a host 192 (e.g., the host 138 discussed with respect to FIG. 5) and the FPGA 70. The system may be a specific embodiment of the system 10 discussed with respect to FIG. 4. In particular, the host 192 may be CXL2 type device that couples to a cache coherency bridge/agent (DCOH) 194 that implements CXL protocol-based communication and the FPGA 70 that accelerates memory operations of the host 192 with the HDM 106 via a computer express link (CXL) 196. The CXL 196 may be used for data transfer between the host 192, the DCOH 194, the FPGA 70, and the memory 106. In other instances, the link coupling the host 192 to the DCOH 194, the FPGA 70, and the memory 106 may be any link type suitable for connecting the components. For example, the link type may be a peripheral component interconnect express (PCIe) link or other suitable link type. Additionally or alternatively, the link may utilize one or more protocols built on top of the link type. For instance, the link type may include a type that includes at least one physical layer (PHY) technology, such as a PCIe PHY. These one or more protocols may include one or more standards to be used via the link type. For instance, the one or more protocols may include compute express link (CXL) or other suitable connection type that may be used over the link (e.g., PCIe PHY).

The DCOH 194 may be responsible for resolving coherency with respect to device cache(s). Specifically, the DCOH 194 may include their own cache(s) that may be maintained to be coherent with the cache(s), such as the host cache, the FPGA 70 cache, and so on. tBboth the FPGA 70 and the host 192 may include respective cache(s). Additionally or alternatively, the DCOH 194 may include the cache (e.g., the cache 104 described with respect to FIG. 4) for the system 190. To this end, the DCOH 194 may store frequency accessed data by the host 192 and/or be prefilled with data by the FPGA 70.

As discussed herein, the FPGA 70 may sit on the memory bus and snoop on requests (e.g., read requests, write requests) from the host 192 to access the memory 106. The memory bus may be a first link 198 between the host 192 and the memory 106. The first link 198 may be an Avalon Memory-Mapped (AVVM) Interface that transmits signals such as a write request and/or a read request and the memory 106 may be an HDM with four double data rate (DDR4). The host 192 may transmit a first read request and/or a first write request to the memory 106 via the first link 198 and the FPGA 70 may snoop on the request being transmitted along the first link 198 without the host 192 knowing. In particular, the FPGA 70 may include one or more AFUs 200 that may be programmed to identify and decode data structures within the memory 106 based on the read requests and/or write requests. For example, the AFU 200 may intercept the read request being transmitted from the host 192 to the memory 106 on the first link 198. Additionally or alternatively, the host 192 may transmit the first read request and/or the first write request to the DCOH 194 (Operation 1) to determine if the data may be already loaded. If the data is not loaded, the DCOH 194 may transmit the first read request and/or the first write request to the memory 106 along the first link 198 (Operation 2) and the AFU 200 may snoop on the request.

As discussed herein, the AFU 200 may be programmed to identify an address and/or a data node within the memory 106 based on the read request and decode the data node to determine the next data node. For example, the AFU 200 may decode the data node to determine an address of the next data node. To this end, the data node may include memory pointers directed to the next data node and/or details of the second node. The AFU 200 may generate a second read request based on the address of the next data node. The AFU 200 may transmit the second read request (Operation 3) that is sent to the memory 106 (Operation 4) to retrieve the next data node and/or the data within the next data node. For example, the AFU 200 may transmit the second read request to the memory 106 via a third link 202. The third link 202 may be Advance eXtensible Interface (AXI) that couples the FPGA 70 to the DCOH 194 and/or the memory 106. That is, in certain instances, the AFU 200 may transmit the second read request to the DCOH 194 via the third link 202 and the DCOH 194 may transmit the second read request to the memory 106 via the second link 202 to load the next data node into the DCOH 194. In this way, the AFU 200 may predict a subsequent memory access without intervention from the host 192, read the data (Operation 5), and prefill the cache in the DCOH 194 with data that the host 192 may use to perform the application. That is, the AFU 200 may preload the data prior to the host 192 calling for the data.

When the host 192 finishes processing the data node, the host 192 may generate a third read request and/or a third write request. The host 192 may transmit the third read request to the DCOH 194 to see if the next data node may be stored within the DCOH 194 prior to transmitting the third read request to the memory 106. Since the AFU 200 loaded the next data node into the DCOH 194, a cache hit may be returned (Operation 6) and the host 192 may retrieve the next data node from the DCOH 194, which may be faster in comparison to retrieving the next data node from the memory 106. As the host 192 is processing the next data node, the AFU 200 may be identifying additional data nodes to prefill the DCOH 194. In this way, the AFU 200 may improve memory access operations and improve device throughput.

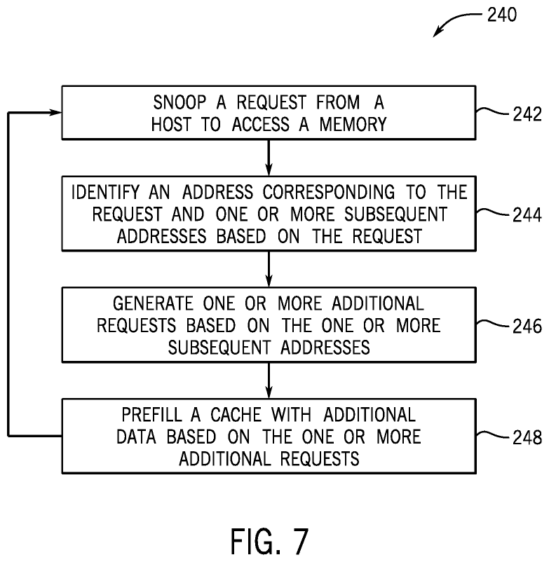

FIG. 7 is a flowchart of an example method 240 for improving memory operations of a CXL2 Type Device, such as the system described with respect to FIG. 6. While the method 240 is described using steps in a specific sequence, it should be understood that the present disclosure contemplates that the described steps may be performed in different sequences than the sequence illustrated, and certain described steps may be skipped or not performed altogether.

At block 242, a request from a host 192 to access a memory 106 may be snooped. For example, the host 192 may perform an application that uses data stored in the memory or writes data to the memory 106. The host 192 may transmit a read request and/or a write request to the memory 106 along the first link 198 and the AFU 200 may snoop on the request. Additionally or alternatively, the host 192 may transmit a read request and/or a write request to DCOH 194 to determine if a cache hit may be returned. If the DCOH 194 does not store the data corresponding to the read request and/or the write request, the DCOH 194 may transmit the read request and/or the write request along the first link 198 and the AFU 200 may snoop on the request.

At block 244, an address and one or more subsequent addresses corresponding to the request may be identified based on the request. For example, the AFU 200 may determine an address (e.g., memory address) corresponding to the request and retrieve a data node at the address from the memory 106. The AFU 200 may decode the data node to identify one or more subsequent addresses and/or one or more next data nodes. That is, the AFU 200 may be programmed with RTL logic, such as intelligent caching mechanisms, to automatically read ahead the next data by decoding the data stored in the memory and using memory pointers in the data node. For example, the data node may include memory pointers that may be used to identify a subsequent data node and/or addition data. Additionally or alternatively, the AFU 200 may identify a whole set of data by decoding the data node and identify the respective subsequent addresses corresponding to the whole set of data.

At block 246, one or more additional requests may be generated based on the one or more subsequent addresses. For example, the AFU 200 may generate one or more read request corresponding to the one or more subsequent address, respectively, and transmit the one or more read requests to the memory 106. As such, the AFU 200 may retrieve additional data that may be used by the host 192 for the application.

At block 248, a cache may be prefilled with additional data based on the one or more additional requests. For example, the AFU 200 may load the additional data corresponding to the one or more additional requests into the DCOH 194. In this way, the DCOH 194 may hold data that may be used by the host 192 for the application, which may reduce an amount of time used retrieve and/or access data. For example, the host 192 may access data stored in the DCOH 194 in less than 50 nanoseconds while the host 192 may use 100 to 200 nanoseconds to access data stored in the HDM DDR4 (e.g., the memory 106). As such, memory access latencies may be reduced by prefilling the cache with data used by the host 192.

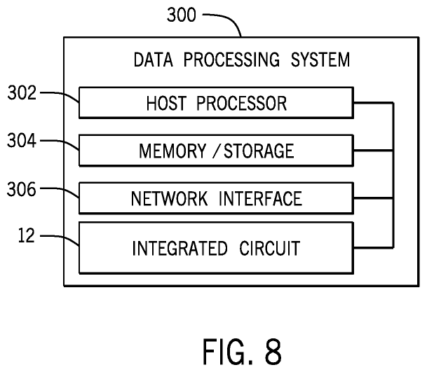

The system 100 described with respect to FIG. 4 and/or the system 190 described with respect to FIG. 6 may be a component included in a data processing system, such as a data processing system 300, shown in FIG. 8. The data processing system 300 may include the system 100 and/or the system 190, a host processor (e.g., the CPU 102) 302, memory and/or storage circuitry 304, and a network interface 306. The data processing system 300 may include more or fewer components (e.g., electronic display, user interface structures, application specific integrated circuits (ASICs)). The integrated circuit device 12 may be used to efficiently programmed to snoop a request from the host and prefill a cache with data based on the request to reduce memory access time. That is, the integrated circuit device 12 may accelerate functions of the host, such as the host processor 302. The host processor 302 may include any of the foregoing processors that may manage a data processing request for the data processing system 300 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 304 may include random access memory (RAM), read-only memory (ROM), one or more hard drives, flash memory, or the like. The memory and/or storage circuitry 304 may hold data to be processed by the data processing system 300. In some cases, the memory and/or storage circuitry 304 may also store configuration programs (e.g., bitstreams, mapping function) for programming the FPGA 70 and/or the AFU 200. The network interface 306 may allow the data processing system 300 to communicate with other electronic devices. The data processing system 300 may include several different packages or may be contained within a single package on a single package substrate. For example, components of the data processing system 300 may be located on several different packages at one location (e.g., a data center) or multiple locations. For instance, components of the data processing system 300 may be located in separate geographic locations or areas, such as cities, states, or countries.

The data processing system 300 may be part of a data center that processes a variety of different requests. For instance, the data processing system 300 may receive a data processing request via the network interface 306 to perform encryption, decryption, machine learning, video processing, voice recognition, image recognition, data compression, database search ranking, bioinformatics, network security pattern identification, spatial navigation, digital signal processing, or other specialized tasks.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

EXAMPLE EMBODIMENT 1. An integrated circuit device including a memory configurable to store a data structure, a cache configurable to store a portion of the structure data, and an acceleration function unit configurable to provide hardware acceleration for a host device. The acceleration function unit may provide the hardware acceleration by intercepting a request from the host device to access the memory, wherein the request comprises an address corresponding to a data node of the data structure, identifying a next data node based at least in part on decoding the data node, and loading the next data node into the cache for access by the host device before the host device calls for the next data node.

EXAMPLE EMBODIMENT 2. The integrated circuit device of example embodiment 1, wherein the acceleration function unit is configured to identify the data structure based on the request and load the data structure into the cache.

EXAMPLE EMBODIMENT 3. The integrated circuit device of example embodiment 1, wherein the acceleration function unit is configurable with register-transfer logic comprising a type of the data structure stored in the memory, a start address of the data structure, a size of the data structure, or a combination thereof.

EXAMPLE EMBODIMENT 4. The integrated circuit device of example embodiment 3, wherein the acceleration function unit is configurable to identify the next data node by determining the address is between the start address and the size of the data structure.

EXAMPLE EMBODIMENT 5. The integrated circuit device of example embodiment 1, wherein the data node comprises a memory pointer to the next data node.

EXAMPLE EMBODIMENT 6. The integrated circuit device of example embodiment 5, wherein the acceleration function unit is configurable to load the next data node into the cache by generating a read request based on the memory pointer in response to identifying the next data node and transmitting the read request to the memory to retrieve the next data node.

EXAMPLE EMBODIMENT 7. The integrated circuit device of example embodiment 1, wherein the acceleration function unit comprises a programmable logic device having a programmable fabric.

EXAMPLE EMBODIMENT 8. The integrated circuit device of example embodiment 7, wherein the programmable logic device comprises a plurality of acceleration function units comprising the acceleration function unit, and wherein each of the plurality of acceleration function units is configurable to provide the hardware acceleration for a plurality of host devices comprising the host device.

EXAMPLE EMBODIMENT 9. The integrated circuit device of example embodiment 1, wherein the acceleration function unit is positioned on a memory bus coupling the host device and the memory.

EXAMPLE EMBODIMENT 10. The integrated circuit device of example embodiment 1, comprising a compute express link type 2 device that exposes the memory to the host device using compute express link memory operations.

EXAMPLE EMBODIMENT 11. An integrated circuit device may include a programmable logic device with an acceleration function unit to provide hardware acceleration for a host device, a memory to store a data structure, and a cache coherency bridge accessible to the host device and configurable to resolve coherency with a host cache of the host device. The acceleration function unit is configurable to prefill the cache coherency bridge with a portion of the data structure based on a memory access request transmitted by the host device.

EXAMPLE EMBODIMENT 12. The integrated circuit device of example embodiment 11, wherein the acceleration function unit is configurable to identify a data node of the data structure corresponding to the memory access request and identify a next data node of the data structure that is linked to the data node based at least in part by decoding the data node.

EXAMPLE EMBODIMENT 13. The integrated circuit device of example embodiment 12, wherein the acceleration function unit is configurable to prefill the cache coherency bridge by transmitting a request to the memory comprising the next data node and loading the next data node into the cache coherency bridge for access by the host device.

EXAMPLE EMBODIMENT 14. The integrated circuit device of example embodiment 12, wherein identifying the next data node comprises identifying a memory pointer of the data node, wherein the memory pointer comprise an address of the next data node.

EXAMPLE EMBODIMENT 15. The integrated circuit device of example embodiment 12, wherein identifying the next data node comprises identifying a next node pointer of the data node, wherein the next node pointer comprises a start signature of the next data node.

EXAMPLE EMBODIMENT 16. The integrated circuit device of example embodiment 11, wherein the acceleration function unit is configurable based on logic comprising a type of the data structure stored in the memory, a start address of the data structure, a size of the data structure, or a combination thereof.

EXAMPLE EMBODIMENT 17. The integrated circuit device of example embodiment 11, wherein the data structure comprises a single linked list, a double linked list, a graph, a map, or a tree.

EXAMPLE EMBODIMENT 18. The integrated circuit device of example embodiment 11, comprising a compute express link type 2 device that exposes the memory to the host device using compute express link memory operations.

EXAMPLE EMBODIMENT 19. A programmable logic device may include a cache coherency bridge comprising a device cache that the cache coherency bridge is to maintain coherency with a host cache of a host device using a communication protocol with the host device over a link and an acceleration function unit to provide a hardware acceleration function for the host device. The acceleration function unit may include logic circuitry to implement the hardware acceleration function in a programmable fabric of the acceleration function unit and a memory that is exposed to the host device as host-managed device memory to be used in the hardware acceleration function. The logic circuitry is configurable to implement the hardware acceleration function by snooping on a first request from the host device indicative of accessing the memory, identifying a first data node of a data structure corresponding to the first request, identifying a second data node of the data structure based at least in part by decoding the first data node. The logic circuitry may also implement the hardware acceleration function by transmitting a second request to the memory comprising an address of the second data node and loading the second data node into the cache coherency bridge for access by the host device.

EXAMPLE EMBODIMENT 20. The programmable logic device of example embodiment 19, wherein the acceleration function unit is configurable based on register-transfer logic comprising a type of the data structure stored in the memory, a start address of the data structure, a size of the data structure, or a combination thereof.

What is claimed is:

1. An integrated circuit device, comprising:
a memory configurable to store a data structure;
a cache configurable to store a portion of the structure data; and
an acceleration function unit configurable to provide hardware acceleration for a host device by:
intercepting a request from the host device to access the memory, wherein the request comprises an address corresponding to a data node of the data structure;
identifying a next data node based at least in part on decoding the data node; and
loading the next data node into the cache for access by the host device before the host device calls for the next data node.

2. The integrated circuit device of claim 1, wherein the acceleration function unit is configured to identify the data structure based on the request and load the data structure into the cache.

3. The integrated circuit device of claim 1, wherein the acceleration function unit is configurable with register-transfer logic comprising a type of the data structure stored in the memory, a start address of the data structure, a size of the data structure, or a combination thereof.

4. The integrated circuit device of claim 3, wherein the acceleration function unit is configurable to identify the next data node by determining the address is between the start address and the size of the data structure.

5. The integrated circuit device of claim 1, wherein the data node comprises a memory pointer to the next data node.

6. The integrated circuit device of claim 5, wherein the acceleration function unit is configurable to load the next data node into the cache by:
generating a read request based on the memory pointer in response to identifying the next data node; and
transmitting the read request to the memory to retrieve the next data node.

7. The integrated circuit device of claim 1, wherein the acceleration function unit comprises a programmable logic device having a programmable fabric.

8. The integrated circuit device of claim 7, wherein the programmable logic device comprises a plurality of acceleration function units comprising the acceleration function unit, and wherein each of the plurality of acceleration function units is configurable to provide the hardware acceleration for a plurality of host devices comprising the host device.

9. The integrated circuit device of claim 1, wherein the acceleration function unit is positioned on a memory bus coupling the host device and the memory.

10. The integrated circuit device of claim 1, comprising a compute express link type 2 device that exposes the memory to the host device using compute express link memory operations.

11. An integrated circuit device, comprising:
a programmable logic device, comprising:
an acceleration function unit to provide hardware acceleration for a host device; and
a memory to store a data structure; and
a cache coherency bridge accessible to the host device and configurable to resolve coherency with a host cache of the host device, wherein the acceleration function unit is configurable to prefill the cache coherency bridge with a portion of the data structure based on a memory access request transmitted by the host device.

12. The integrated circuit device of claim 11, wherein the acceleration function unit is configurable to:
identify a data node of the data structure corresponding to the memory access request; and
identify a next data node of the data structure that is linked to the data node based at least in part by decoding the data node.

13. The integrated circuit device of claim 12, wherein the acceleration function unit is configurable to prefill the cache coherency bridge by:
transmitting a request to the memory comprising the next data node; and
loading the next data node into the cache coherency bridge for access by the host device.

14. The integrated circuit device of claim 12, wherein identifying the next data node comprises identifying a memory pointer of the data node, wherein the memory pointer comprise an address of the next data node.

15. The integrated circuit device of claim 12, wherein identifying the next data node comprises identifying a next node pointer of the data node, wherein the next node pointer comprises a start signature of the next data node.

16. The integrated circuit device of claim 11, wherein the acceleration function unit is configurable based on logic comprising a type of the data structure stored in the memory, a start address of the data structure, a size of the data structure, or a combination thereof.

17. The integrated circuit device of claim 11, wherein the data structure comprises a single linked list, a double linked list, a graph, a map, or a tree.

18. The integrated circuit device of claim 11, comprising a compute express link type 2 device that exposes the memory to the host device using compute express link memory operations.

19. A programmable logic device, comprising:
a cache coherency bridge comprising a device cache that the cache coherency bridge is to maintain coherency with a host cache of a host device using a communication protocol with the host device over a link; and
an acceleration function unit to provide a hardware acceleration function for the host device and comprising:
logic circuitry to implement the hardware acceleration function in a programmable fabric of the acceleration function unit; and
a memory that is exposed to the host device as host-managed device memory to be used in the hardware acceleration function,
wherein the logic circuitry is configurable to implement the hardware acceleration function by:
snooping on a first request from the host device indicative of accessing the memory;
identifying a first data node of a data structure corresponding to the first request;
identifying a second data node of the data structure based at least in part by decoding the first data node;
transmitting a second request to the memory comprising an address of the second data node; and
loading the second data node into the cache coherency bridge for access by the host device.

20. The programmable logic device of claim 19, wherein the acceleration function unit is configurable based on register-transfer logic comprising a type of the data structure stored in the memory, a start address of the data structure, a size of the data structure, or a combination thereof.
